(19) United States
(12) Patent Application Publication
(10) Pub. No.: US 2012/0003893 A1
(43) Pub. Date: Jan. 5, 2012

(54) Composite Nanofibers

(76) Inventor: Kelly D. Branham, Woodstock, GA (US)

(21) Appl. No.: 12/825,581

(22) Filed: Jun. 29, 2010

(51) Int. Cl. D04H 13/00; B32B 5/02; B29C 47/00; D02G 3/36; B82Y 30/00; B82Y 40/00

(52) U.S. Cl. 442/332; 264/465; 428/372; 442/330; 442/377; 442/335; 977/842; 977/742; 977/773

(57) ABSTRACT

The present invention is generally directed to, in one embodiment, a composite nanofiber having a plurality of nanoparticles retained on the surface of the nanofiber, and a process for forming such composite nanofibers.

### BACKGROUND OF THE INVENTION

Webs containing nanofibers have recently been explored due to the high pore volume, high surface area to mass ratio, and other characteristics that nanofibers may provide. Nanofibers have been produced by a variety of methods and from many different materials. Selected types of nanofibers are produced by electrospinning processes. Electrospinning, also known as electrostatic spinning, refers to a technology which produces fibers from a polymer solution or polymer melt using interactions between fluid dynamics, electrically charged surfaces and electrically charged liquids.

While nanofibers may provide preferred filtration, odor absorption, chemical barrier and other properties, such properties may be enhanced by the addition of selected nanoparticles which may be trapped or retained on the nanofiber or within the nanofiber web. For certain applications, it is advantageous to include high levels of nanoparticles (that is, greater than about 30% of nanoparticles by weight in the web) to increase the benefit provided by the web. The advantage provided by high levels of nanoparticles in a nanofiber web may be particularly useful in barrier fabrics which are intended to protect against chemical and biological agents, filtration application and delivery of various substances.

### SUMMARY OF THE INVENTION

An embodiment of the present invention is directed to a composite nanofiber including an electrospun nanofiber having a longitudinal axis and a plurality of cylindrical nanoparticles disposed on the nanofiber. In selected embodiments, the electrospun nanofiber is substantially covered by the cylindrical nanoparticles. The cylindrical nanoparticles each have a central axis, and the central axes of at least a portion of the cylindrical nanoparticles may be in alignment with the longitudinal axis of the nanofiber.

In such an embodiment, the nanoparticles may be selected from the group consisting of metals, metal compounds, ceramics and clays. In certain embodiments, the nanoparticles may be halloysite clay nanotubes. The cylindrical nanoparticles may be nanorods or nanotubes, such as halloysite clay nanotubes.

The composite nanofiber of the present invention may include a nanofiber having an exterior surface and a plurality of nanoparticles, each nanoparticle having an average width that is less than about one-third of the average width of the electrospun nanofiber, the plurality of nanoparticles being disposed on the exterior surface of the nanofiber. The average width of the nanoparticle may be less than one quarter of the average width of the nanofiber, and may be less than the one eighth of the average width of the nanofiber.

The present invention further includes a web including composite nanofibers, the composite nanofibers including a nanofiber having an average diameter of less than about 1000 nanometers and an exterior surface. The web further includes a plurality of nanoparticles disposed on the exterior surface of the nanofiber. In selected embodiments, the weight percent of nanoparticles on the composite fibers is greater than about 30 percent of the combined weight of the nanoparticles and nanofibers. In particular embodiments, the weight percent of nanoparticles on the composite fibers is less than about 90 percent of the combined weight of the nanoparticles and nanofibers. Certain embodiments of the invention include nanoparticles having an average aspect ratio great than one, and may include nanoparticles having an average aspect ratio of less than 500.

The present invention further includes a web formed by a method which may include the steps of providing a polymer solution and dispersing nanoparticles into the polymer solution. The weight of the nanoparticles relative to the total weight of the polymer and nanoparticles in the web and in the spinning solution may be between about 30% and about 95% by weight. In certain embodiments, the nanoparticles may comprise between about 50% and about 90% by weight, or may comprise between about 60% and about 80% by weight, although other ranges of nanoparticle weights are also contemplated in the present invention.

The solution is electrospun onto a collecting surface, forming the composite nanofibers. The nanoparticles may be selected from the group consisting of metals, metal compounds, ceramics and clays. The nanoparticles may have a variety of shapes, but may be formed as cylindrical nanoparticles.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a photomicrograph of a web of the present invention;

FIG. 2 is a photomicrograph of a web of the present invention produced by Example 1;

FIGS. 3 and 4 are photomicrographs of composite fibers of the present invention produced by Example 2;

FIG. 5 is a photomicrograph of composite fibers of the present invention produced by Example 3;

FIG. 6 is a photomicrograph of a web of the present invention produced by Example 4;

FIG. 7 is a photomicrograph of a web of the present invention produced by Example 6;

FIGS. 8 and 9 are photomicrographs of webs of the present invention produced by Example 8;

FIG. 10 is a photomicrograph of a web of the present invention produced by Example 10;

FIG. 11 is photomicrographs of webs of the present invention produced by Example 11; and

FIG. 12 is a photomicrograph of a web of the present invention produced by Example 12.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. It will be apparent to those skilled in the art that various modifications and variations can be made in the present invention without departing from the scope or spirit of the invention. Features illustrated or described as part of one embodiment, can be used on another embodiment to yield a still further embodiment. It is intended that the present invention covers such modifications and variations within the scope of the appended claims and their equivalents. It should be noted that any given range presented herein is intended to include any and all lesser included ranges. For example, a range of from 45-90 would also include 50-90; 45-80; 46-89 and so forth.

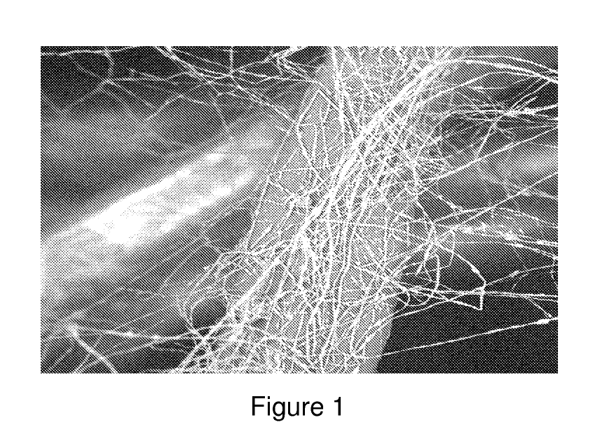

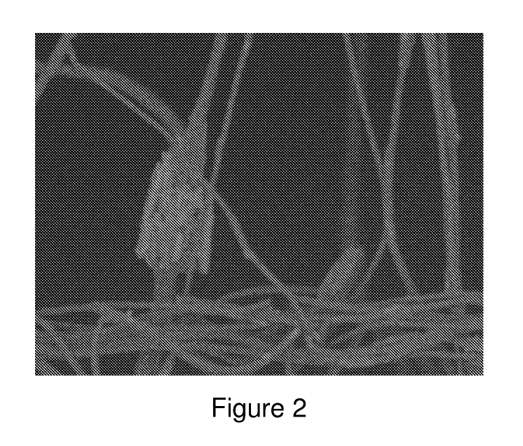

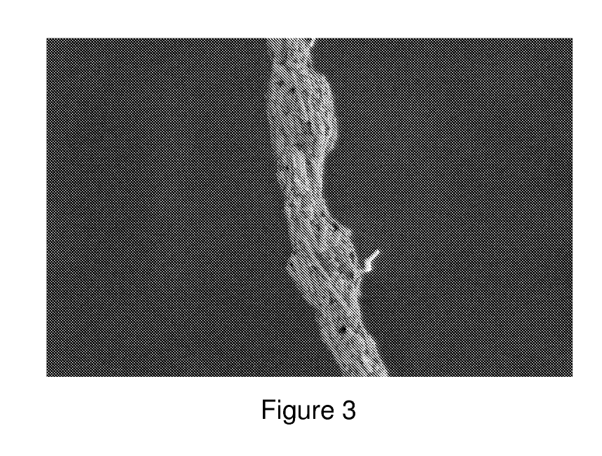

The present invention generally relates to composite nanofibers and webs of such fibers. The composite nanofiber includes a nanofiber and a plurality of nanoparticles disposed on the exterior surface of the nanofiber. A web which includes the composite nanofibers are shown in the photomicrographs of FIGS. 1, 2 and 3. Specifically, FIG. 1 shows composite nanofibers of the present invention which have been collected on a 30.5 grams per square meter (gsm) nonwoven web. FIG. 2 is a photomicrograph of a web containing a composite nanofiber. FIG. 3 is a higher magnification view of a single composite nanofiber according to the present invention, showing nanoparticles covering the exterior surface of the electrospun nanofiber.

The photomicrographs of the composite fibers were obtained with a Hitachi Field Emission Scanning Electron Microscope (FESEM) 4800, although other high resolution microscopes may also be used to take high resolution images of the composite fibers.

The nanofibers of the present invention may be electrospun nanofibers. As used herein, a “nanofiber” is defined as a fiber which has an average diameter of approximately 1,000 nanometers or less. While the average diameter of nanofibers may vary widely and include fibers having average diameters that may range up to about 1,000 nanometers, it is generally understood that the average diameter of nanofibers in a web will be in the range of from about 100 to about 500 nanometers. In other embodiments, the average diameter of the nanofibers may be in the range of from about 200 to about 300 nanometers.

A variety of electrospinning processes are commonly available, and many publications are available which describe fully the electrospinning process and its controlling variables, such as, for example, solution viscosity, the distance between the spinning tip or electrode and the collector, voltage and solution conductivity. In particular, a spinning system referred to as a “Nanospider” system is useful in forming the composite fibers of the present invention. Elmarco, “Nanospider for Nonwovens”, Technische Textilien 2005, 48.3 (E174) (Ref: World Textile Abstracts 2006), discloses the Nanospider spinning technology. A more complete description of this process and equipment are provided in WO 2005/024101 A1, which is incorporated herein by reference. A Nanospider NS-200S electrospinning lab unit (available from Elmarco, Liberec, Czech Republic) was used to spin the composite fibers of the present invention onto various substrates.

The Nanospider system includes positioning a charged electrode that is at least partially immersed in a polymer solution. A rotary electrode assembly was used to spin each of the examples of the present invention. The rotary electrode assembly includes two spaced apart disks, each disk being concentrically mounted on an end of a shaft. Electrically conductive wires which form electrodes extend from one disk to the other disk, running substantially parallel to the shaft, the wires passing through a radially extending groove in one disk to a radially extending groove in the other disk. The shaft forms the axis of rotation of the end disks and electrodes. There may be 6 or 12 electrodes on a rotary electrode assembly. The electrodes are preferably electrically connected to each other. The rotary electrode is more fully described in WO2005/024101 and US20100034914A1, both of which are hereby incorporated by reference.

A ground or counter electrode is positioned opposite to the charged rotary electrode so that an electrostatic field is created between the charged rotary electrode and ground at the peak of the charged electrode. The polymer solution is formulated to enable the creation of conical shapes (referred to as Taylor cones) in the thin layer on the surface of the charged electrode. In particular, the electrical conductivity, viscosity, polymer concentration, temperature and surface tension of the polymer solution are controlled to create appropriate spinning conditions.

At a certain voltage range, a fine jet of polymer solution forms at the tip of the Taylor cone and shoots toward the counter electrode. Forces from the electric field accelerate and stretch the jet. This stretching, together with evaporation of solvent molecules, causes the jet diameter to become smaller. As the jet diameter decreases, the charge density increases until electrostatic forces within the polymer overcome the cohesive forces holding the jet together (e.g., surface tension), causing the jet to split or “splay” into a multifilament of polymer nanofibers. The fibers continue to splay until they reach the collector, where they are collected as nanofibers. As the fibers approach the grounded collector, the electrical forces cause a whipping affect which results in the nanofibers being spread out onto the collector. A material, such as a woven or nonwoven web or film may be positioned between the collector and the charged electrode to collect the nanofibers.

As discussed above, the electrospun nanofibers may be formed directly onto a surface of a material such as a film, a woven web or nonwoven web. As used herein the term “nonwoven” fabric or web means a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, hydroentangling processes, etc.

The term “spunbond fibers”, as used herein, refers to small diameter substantially continuous fibers that are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. Spunbond fibers may be single component or multi-component fibers, and may include a single layer of spunbond materials or multiple layers of spunbond and other materials. Suitable multi-layered materials may include, for instance, spunbond-meltblown-spunbond (SMS) laminates, spunbond-film laminates, and spunbond-meltblown (SM) laminates. Films useful in the present invention may be mono- or multi-layered films.

The composite nanofibers may be produced by electrospinning a polymer solution that contains the desired particles, polymeric materials and solvents. The polymeric materials are combined with a solvent to form the polymer solution. A variety of solvents may be used. For example, the solvent and/or solvent system can include, but are not limited to, water, acetic acid, acetone, acetonitrile, alcohol (e.g., methanol, ethanol, propanol, isopropanol, butanol, and the like), dimethyl formamide, alkyl acetate (e.g., ethyl acetate, propyl acetate, butyl acetate, etc.), polyethylene glycols, propylene glycol, butylene glycol, ethoxydiglycol, hexylene glycol, methyl ethyl ketone, or mixtures thereof.

Many different polymer solutions are suited for use in the present invention. For example, such polymers include, but are not limited to, polyolefins, polyethers, polyacrylates, polyesters, polyamides, polyimides, polysiloxanes, polyphosphazines, vinyl homopolymers and copolymers, as well as naturally occurring polymers such cellulose and cellulose ester, natural gums and polysaccharides. Solvents that are known to be useful to dissolve the above polymers for solution electrospinning include, but are not limited to, alkanes, chloroform, ethyl acetate, tetrahydrofuran, dimethyl formamide, dimethyl acetamide, dimethyl sulfoxide, acetonitrile, acetic acid, formic acid, ethanol, propanol, and water.

In particular, polyvinyl alcohol (PVOH) is a polymeric material that is useful in the present invention. Polyvinyl alcohol is a synthetic polymer that may be formed, for instance, by replacing acetate groups in polyvinyl acetate with hydroxyl groups according to a hydrolysis reaction. The basic properties of polyvinyl alcohol depend on its degree of polymerization, degree of hydrolysis, and distribution of hydroxyl groups. In terms of the degree of hydrolysis, polyvinyl alcohol may be produced so as to be fully hydrolyzed (e.g., greater than about 99% hydrolyzed) or partially hydrolyzed. By being partially hydrolyzed, the polyvinyl alcohol may contain vinyl acetate units.

Other components may also be included within the polymer solution to affect the resulting composite electrospun nanofibers. Since the electrospinning process can be performed at room temperatures with aqueous systems, relatively volatile or thermally unstable additives may be included within the nanofibers. Depending on processing or end use requirements, a skilled artisan may employ any or combinations of additives such as, for example, viscosity modifiers, surfactants, plasticizers, and the like.

Many materials may be used as nanoparticles in the present invention. As used herein, “nanoparticles” are particles which have an average diameter between about 10 and 100 nanometers, and in selected embodiments have a width which is between about 20 and 50 nanometers. The nanoparticles used in the present invention may have a variety of shapes and particle sizes. In some embodiments, the selection of a particular aspect ratio of the nanoparticles may provide benefits in both spinning and to the composite nanofiber. As used herein, “average aspect ratio” is the average width of a particle divided by its average length or range of lengths. In some embodiments, nanoparticles having an average aspect ratio of greater than one may be particularly suited for use in the present invention. In selected embodiments, nanoparticles having an average aspect ratio of from about 2 to about 200 would be useful in the present invention, although nanoparticles having average aspect ratios outside of this range may also be useful in the present invention.

In general, materials such as silica, carbon, clay, mica, calcium carbonate, and other materials are suitable for use in the present invention. In some embodiments of the present invention, less conductive materials may produce more uniform and satisfactory results than materials with higher conductivities. The conductivity of a base material may be modified by various means to enable appropriate spinning. Selected metals and metal compounds and metal oxides may also be suitable for use in the present invention, such as, for example, Group IB-VIIB metals from the periodic table. Metal oxides such as manganese(II,IIII) oxide (Mn₃O₄), silver (I, III) oxide (AgO), copper(I) oxide (Cu₂O), silver(I) oxide (Ag₂O), copper (II) oxide (CuO), nickel (II) oxide (NiO), aluminum oxide (Al₂O₃), tungsten (II) oxide (W₂O₃), chromium(IV) oxide (CrO₂), manganese (IV) oxide (MnO₂), titanium dioxide (TiO₂), tungsten (IV) oxide (WO₂), vanadium (V) oxide (V₂O₅), chromium trioxide (CrO₃), manganese (VII) oxide, Mn₂O₇), osmium tetroxide (OsO₄) and the like may be useful in the present invention.

The composite nanofibers shown in the figures were spun with particles of cylindrically-shaped halloysite clay nanotubes. Halloysite clay nanotubes are a naturally occurring aluminosilicate nanoparticle having the following chemical formulation: Al₂Si₂O₅(OH)₄2H₂O. It is a two-layered aluminosilicate, with a predominantly hollow tubular structure in the submicron range. The neighboring alumina and silica layers naturally curve and form multilayer tubes. Halloysite is an economically advantaged material that can be mined from the deposit as a raw mineral. Chemically, the outer surface of the halloysite nanotubes has properties similar to SiO₂ while the inner lumen has properties similar to Al₂O₃. The charge (zeta potential) behavior of halloysite particles can be roughly described by superposition of the mostly negative (at pH 6-7) surface potential of SiO₂, with a small contribution from the positive Al₂O₃ inner surface. The positive (below pH 8.5) charge of the inner lumen enables the inner lumen of the nanotube to be loaded with negatively charged macromolecules, which are at the same time repelled from the negatively charged outer surfaces.

In some embodiments of the present invention, the halloysite clay nanotubes may be spun so that the longitudinal axis of at least a portion of the clay nanotubes is in approximate alignment with the longitudinal axis of the nanofiber. This alignment may provide enhanced mechanical properties to the composite nanofiber.

A wide range of active agents, including drugs, biocides and other substances can be positioned within the inner lumen of the nanotube. The retention and controlled release of active agents from the inner lumen makes the halloysite clay nanotubes well-suited for numerous delivery applications. The composite nanofibers of the present invention may also be used to form webs which provide unique strength reinforcement, scratch protection and excellent filtration properties.

To produce the examples of the present invention, halloysite clay nanotubes were obtained from two different suppliers. Halloysite clay nanotubes having an average diameter of about fifty (50) nm and lengths which ranged between about 500 to 2000 nm were obtained from Macro-M (Lermo, EDO Mex). Halloysite clay nanotubes which were purchased from Sigma-Aldrich (St. Louis, Mo.) were also used, and have an average outer diameter of about thirty (30) nm and lengths that ranged between about 500-4000 nm. The aspect ratios of the nanotubes utilized in the examples range from about 10 to about 133, although nanoparticles with other aspect ratios may also be utilized in the present invention.

As noted above, the examples were spun on a Nanospider NS-200S electrospinning lab unit available from Elmarco (Liberec, Czech Republic). The parameters controlled to achieve the desired spinning results were electric voltage (E in kV), forming height (H, in mm, which is the distance between the electrode and collection fabric), speed of the collection fabric (kept constant at 6 Hz or 0.52 feet/minute, and electrode spinning rate (S in Hz).

The polymer utilized in the spinning solution of each example was a polyvinyl alcohol (PVOH) obtained from Sigma-Aldrich having a molecular weight range of 85,000 to 124,000 and 87-89% hydrolyzed. The polymer powder was dispersed in deionized water at room temperature with a high speed mixer. The mixture was then placed in a water bath at 70-75 degrees C. and stirred for at least one hour. Clear solutions of completely solubilized PVOH were obtained for all examples. The final percent of polymer solids was determined on a solids analyzer. Final formulations were made by either diluting the polymer stock solution and adding the desired level of particles by blending with a high speed mixer, or by dispersing the particles into the dilution water and blending the dilution water into the polymer stock with a high speed mixer. Stirring was continued until a homogenous dispersion was obtained. In some embodiments, the polymer powder and the particles were added simultaneously to deionized water to give the desired level of solids and ratio of particle to polymer. Dissolution of the polymer and dispersion of the particles were affected by use of a high shear rotor-stator mixer.

The polymer solution or dispersion was placed in a horizontal vat containing a 6 or 12 wire rotary electrode. The wire which formed the electrode had a diameter of about 200 μm, and was symmetrically wound across the end disks to yield the spinning surfaces. Either a thin wire (500 μm×35 cm) or a metal cylinder (20 cm×8 cm) was used as the ground. An electric field was applied between the solution and the ground, resulting in nanofibers being formed from the surface of the spinning electrode and deposited onto the web that is in front of the ground plate.

Table 1 shows the processing conditions for each of the twelve examples. Column 6 reports the percent by weight of the halloysite clay nanotubes (HNT) and the PVOH.

TABLE 1
Processing Conditions

| | | | | | % by | | |
|---|---|---|---|---|---|---|---|
| | | | | | Weight of | # of | |
| | | | | | HNT (of | Wire | |
| | | H | S | HNT | HNT & | Elec- | |
| Example | E (kV) | (mm) | (Hz) | Source | PVOH) | trodes | Ground |
| 1 | 50.3 | 130 | 20.0 | Macro-M | 30 | 6 | Wire |
| 2 | 62.1 | 100 | 16.7 | Macro-M | 90 | 6 | Wire |
| 3 | 58.3 | 120 | 17.4 | Macro-M | 80 | 6 | Wire |
| 4 | 60.1 | 110 | 52.0 | Macro-M | 69 | 6 | Cylinder |
| 5 | 60.1 | 110 | 52.0 | Macro-M | 75 | 6 | Cylinder |
| 6 | 58.6 | 110 | 52.0 | Macro-M | 80 | 6 | Cylinder |
| 7 | 59.1 | 110 | 52.0 | Macro-M | 80 | 12 | Cylinder |
| 8 | 58.0 | 110 | 52.3 | Aldrich | 80 | 6 | Cylinder |
| 9 | 60.0 | 110 | 52.0 | Aldrich | 80 | 6 | Cylinder |
| 10 | 65.8 | 110 | 52.0 | Aldrich | 80 | 12 | Cylinder |
| 11 | 65.8 | 110 | 52.0 | Aldrich | 80 | 12 | Cylinder |
| 12 | 60.8 | 110 | 52.4 | Aldrich | 90 | 6 | Cylinder |

Example 1 was formed by dispersing 9.0 grams of halloysite clay nanotubes from Macro-M into 90 grams of deionized water in a Caframo mixer (RZR 50), although any other suitable mixer may be utilized. 156.7 grams of PVOH solution (13.4% by weight PVOH) was added to this dispersion during stirring. The dispersion, which contained 30% by weight of HNTs, was electrospun at a voltage of 50.3 kV, a forming height of 130 mm, and an electrode spinning rate of 20.0 Hz, as indicated in Table 1. The dispersion was spun onto a 110 gsm spunbond nonwoven web available under the designation “Intrepid 684L” from Kimberly-Clark Corporation. A photomicrograph of a portion of the web produced in Example 1 shows a composite nanofiber.

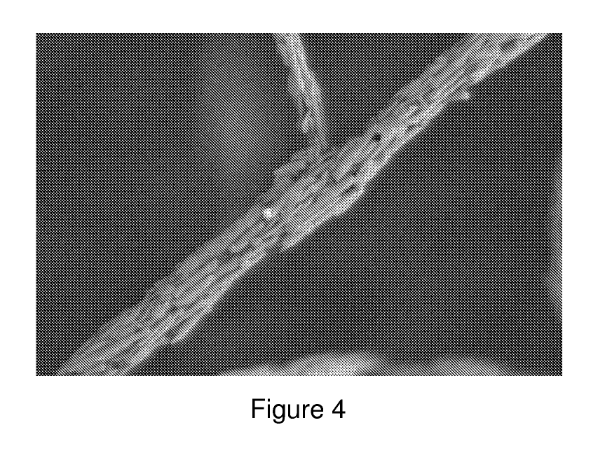

Example 2 was formed by adding HNTs to deionized water and stirring in a jiffy mixer to form a first dispersion of 47.6% HNTs and deionized water. 189.1 grams of the first dispersion were combined with 20 grams of deionized water and 64.1 grams of an aqueous PVOH solution (15.6% by weight) until a homogenous second dispersion was obtained. The second dispersion contained 90% by weight halloysite clay nanotubes. The second dispersion was electrospun using the conditions listed in Table 1 onto a 0.4 osy polypropylene spunbond web manufactured by Kimberly-Clark. FIGS. 3 and 4 are photomicrographs of composite nanofibers formed in Example 2. The halloysite clay nanotubes may be clearly seen in FIGS. 3 and 4, which shows the propensity for alignment between the central axes of at least a portion of the halloysite clay nanotubes and the longitudinal axis of the nanofiber. Clumps of halloysite clay nanotubes also form on the nanofiber, as seen in both FIGS. 2 and 3.

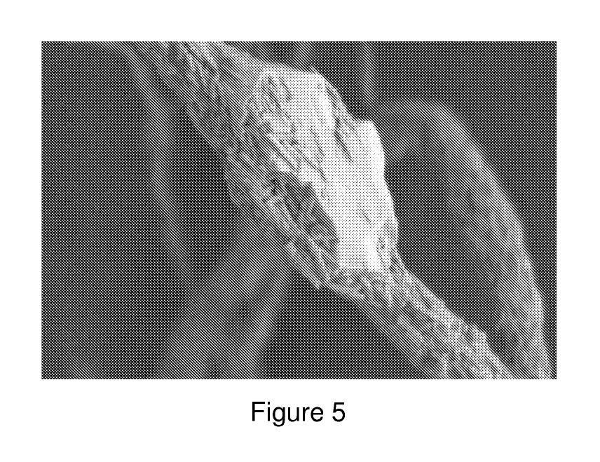

In Example 3, 80.0 grams of HNTs were dispersed in 100 grams of deionized water by stirring, to which 128.2 grams of an aqueous PVOH solution (15.6% by weight) was added with continued stirring. The resulting dispersion, which contained 80% by weight HNTs, was electrospun using the conditions listed in Table 1 onto a 0.4 osy polypropylene spunbond web manufactured by Kimberly-Clark. FIG. 5 is a photomicrograph of a composite fiber formed in Example 3. While not wishing to be bound by theory, it is believed that the HNTs are in contrast to a relatively large section of what is believed to be undissolved polymer. The alignment of HNTs with the longitudinal axis of the nanofiber is shown in FIG. 5, the alignment of HNTs around the larger particle is less orderly than along other portions of the nanofiber.

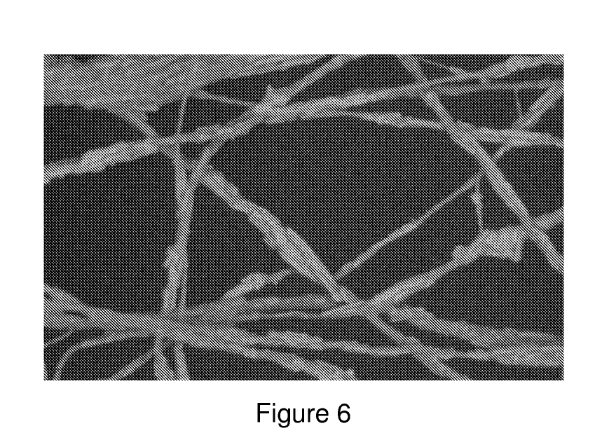

Example 4 was prepared by dispersing 80.0 grams of HNTs into 125 grams of deionized water, to which 170.9 grams of an aqueous PVOH solution (20.9% by weight) and 40.0 grams of ethyl alcohol, which was obtained from Sigma-Aldrich under the designation EtOH. The dispersion was electrospun using the conditions listed in Table 1 onto a 30.5 gsm bonded carded web. FIG. 6 shows a number of composite nanofibers produced according to Example 4.

Example 5 was prepared by dispersing 80.0 grams of HNTs into 125 grams of deionized water, to which 128.2 grams of an aqueous PVOH solution (20.9% by weight) and 40.0 grams of ethyl alcohol, which was obtained from Sigma-Aldrich under the designation EtOH. The dispersion was electrospun using the conditions listed in Table 1 onto a 30.5 gsm bonded carded web.

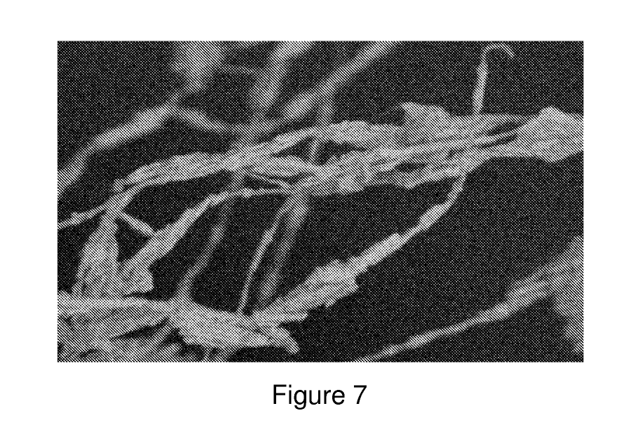

In Example 6, 168.8 grams of a 47.4% aqueous dispersion of HNTs in deionized water was combined with 85.0 grams of deionized water and 95.7 grams of an aqueous PVOH solution (20.9% by weight) and stirred. 40.0 grams of ethyl alcohol was added to the dispersion and then mixed with a Ross ME-100L high shear rotor-stator mixer at medium speed for about five minutes. The dispersion was permitted to cool to room temperature (from approximately 44 degrees C. to approximately 27 degrees C.) prior to spinning as frictional heating had caused the temperature of the dispersion to rise. The dispersion, containing 80% by weight HNTs, was spun using the conditions listed in Table 1 onto a 30.5 gsm bonded carded web. FIG. 7 is a photomicrograph of composite nanofibers produced in Example 6.

Example 7 was formed by adding 168.8 grams of a 47.4% aqueous dispersion of HNTs in deionized water was combined with 60.0 grams of deionized water and 95.7 grams of an aqueous PVOH solution (20.9% by weight) and stirred. 37.0 grams of ethyl alcohol was added to the dispersion and then mixed with a Ross ME-100L high shear rotor-stator mixer, at a medium speed for about five minutes. The dispersion was permitted to cool to room temperature as noted above prior to spinning as frictional heating had caused the temperature of the dispersion to rise. The dispersion, containing 80% by weight HNTs, was spun using the conditions listed in Table 1 onto a 30.5 gsm bonded carded web.

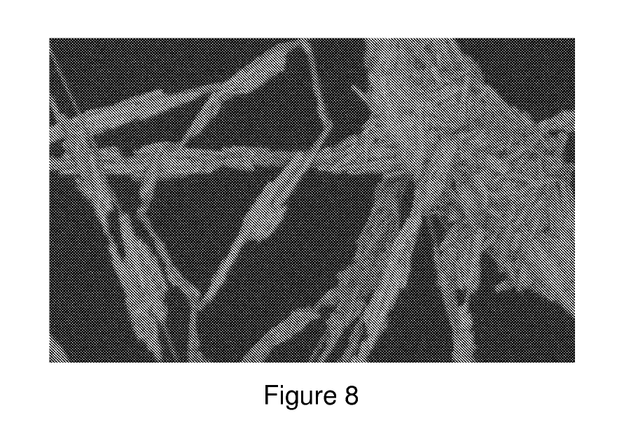

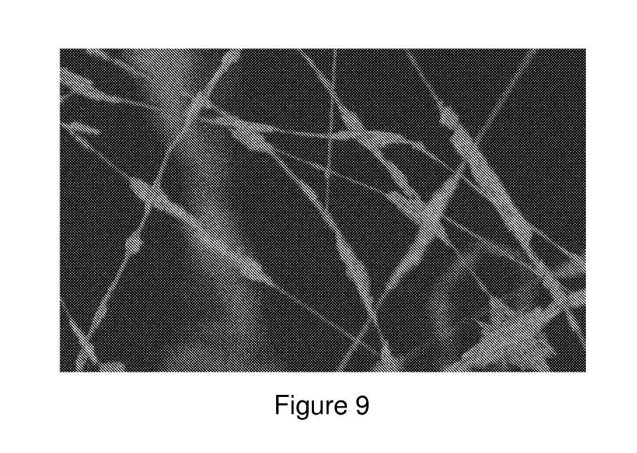

In preparing Example 8, a 32.7% by weight aqueous dispersion was prepared by combining dry HNTs with deionized water in a Ross ME-100L high shear rotor-stator mixer. The dispersion was permitted to cool to room temperature prior to adding 95.7 grams of an aqueous PVOH solution (20.9% by weight PVOH) to 244.6 grams of the dispersion. The dispersion was stirred using a jiffy mixer and stir motor. Ethyl alcohol in an amount of 38.0 grams was added to the dispersion. The dispersion was spun using the conditions listed in Table 1 onto a 30.5 gsm bonded carded web. FIGS. 8 and 9 show a number of the composite nanofibers formed in Example 8. Although the clarity of the photomicrograph is less than the clarity of some other figures, the tendency of the nanotubes to align along the longitudinal axis of the nanofiber can be seen. As seen in FIGS. 5 and 8, the tendency of the HNTs to have less alignment when they are adjacent to a large cluster or clump of material can be seen.

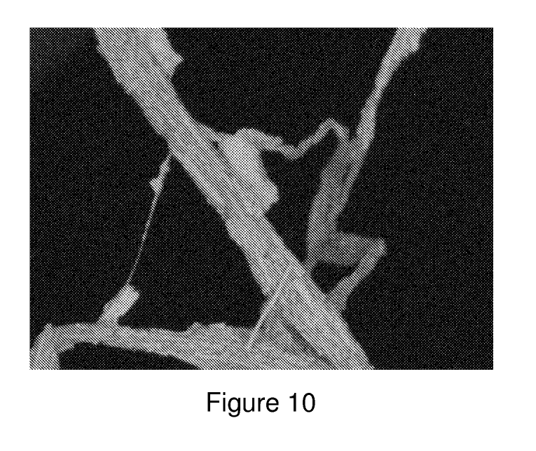

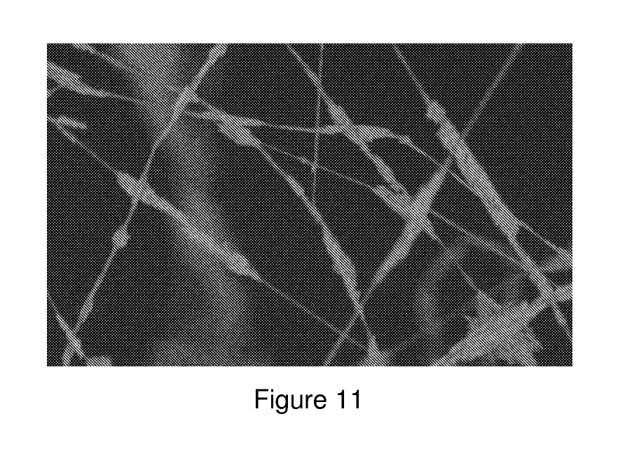

The dispersions used in Examples 9, 10 and 11 were prepared using the same process. 24.0 grams of dry PVOH powder and 96 grams of HNTs were mixed in a beaker, to which 240 grams of deionized water was added. This dispersion was mixed in a Ross ME-100L high shear rotor-stator mixer for about 10 minutes. Frictional heating caused the temperature of the dispersion to rise, and 42.0 grams of ethyl alcohol was added prior to the dispersion returning to room temperature. After the dispersion containing 80% by weight HNTs returned to room temperature, it was electrospun using the conditions listed in Table 1 onto a 30.5 gsm bonded carded web. FIGS. 10 and 11 show composite nanofibers produced in Examples 10 and 11, respectively.

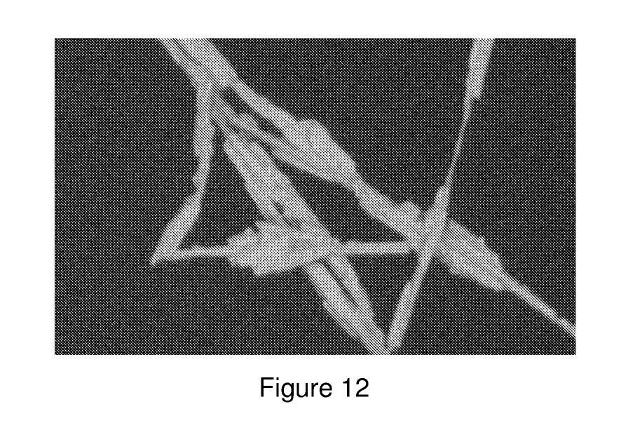

For Example 12, 108 grams of HNTs and 12 grams of dry PVOH powder were mixed in a beaker and added to 240 grams of deionized water. The mixture was mixed with a Ross ME-100L high shear rotor-stator mixer for approximately ten minutes. Frictional heating caused the temperature of the dispersion to rise, and 42.0 grams of ethyl alcohol was added to the dispersion. The dispersion of 90% by weight HNTs was permitted to cool to room temperature and was spun using the conditions in Table 1 onto 30.5 gsm bonded carded web. FIG. 12 is a photomicrograph of composite nanofibers produced in Example 12.

The examples demonstrate that the composite nanofibers and webs of the present invention capture levels of nanoparticles which range from at least about 30% to at least about 90% by weight of the nanoparticles and polymer combined, and in selected embodiments the preferential alignment of those nanoparticles.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A composite nanofiber comprising:
a nanofiber having an average diameter of less than 1000 nanometers and a longitudinal axis; and
cylindrical nanoparticles disposed on the nanofiber, the cylindrical nanoparticles having an average aspect ratio greater than 1 and less than 500.

2. The composite nanofiber of claim 1, the cylindrical nanoparticles being nanotubes.

3. The composite nanofiber of claim 2, the cylindrical nanoparticles being halloysite clay nanotubes.

4. The composite nanofiber of claim 1, the nanoparticles being selected from the group consisting of metals, metal compounds, ceramics and clays.

5. A substrate comprising a plurality of composite nanofibers as claimed in claim 1.

6. A web comprising composite nanofibers, the composite nanofibers comprising:
a nanofiber having an average diameter of less than about 1000 nanometers and an exterior surface; and
a plurality of nanoparticles disposed on the exterior surface of the nanofiber, wherein the weight percent of nanoparticles on the composite fibers is greater than 30 percent of the combined weight of the nanoparticles and nanofibers.

7. The web of claim 6, wherein the nanoparticles have an average aspect ratio great than one.

8. The web of claim 6, wherein the nanoparticles have an average aspect ratio less than 500.

9. The web of claim 6, the nanoparticles being cylindrical nanoparticles.

10. The web of claim 6, the nanoparticles being selected from the group consisting of metals, metal compounds, ceramics and clays.

11. The web of claim 6, the nanoparticles being clay nanoparticles.

12. The web of claim 11, the nanoparticles being halloysite clay nanotubes.

13. A web formed by the method comprising:
providing a polymer solution;
dispersing nanoparticles into the polymer solution wherein the nanoparticles comprise between about 30% and about 95% by weight of the polymer and nanoparticles; and
electrospinning composite nanofibers onto a collecting surface such that at least a portion of the nanoparticles are on the surface of the nanofibers.

14. The web of claim 13, the nanoparticles comprising between about 50% and about 90% by weight of the polymer and nanoparticles.

15. The web of claim 13, the nanoparticles comprising between about 60% and about 90% by weight of the polymer and nanoparticles.

16. The web of claim 13, the nanoparticles being selected from the group consisting of metals, metal compounds, ceramics and clays.

17. The web of claim 13, wherein the nanoparticles have an average aspect ratio great than one and less than 500.

18. The web of claim 13, wherein at least a portion of the nanoparticles are cylindrical nanoparticles.

19. The web of claim 13, wherein at least a portion of the nanoparticles are halloysite clay nanotubes.
